(19) United States
(12) Patent Application Publication
(10) Pub. No.: US 2010/0170906 A1
(43) Pub. Date: Jul. 8, 2010

(54) TANK

(75) Inventor: Yasuyuki Iida, Toyota-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi, Aichi (JP)

(21) Appl. No.: 12/601,438

(22) PCT Filed: May 20, 2008
(86) PCT No.: PCT/JP2008/059607

§ 371 Date: Feb. 5, 2010

(30) Foreign Application Priority Data
May 24, 2007 (JP) 2007-137418

(51) Int. Cl. F17C 1/00; B65D 90/02

(52) U.S. Cl. 220/586; 220/660

(57) ABSTRACT

A tank for storing gas is provided with a dye capsule layer including capsules containing dye or with an impact recording layer formed on the outer surface of the tank body. The impact recording layer has, for example, a hear-insulating material layer formed on the outer surface of the tank body, having a heat-insulating function, and capable of holding deformation, a dye capsule layer formed on the outer surface of the heat-insulating layer and including capsules containing dye, and a dye absorbing layer formed on the outer surface of the dye capsule layer and capable of absorbing dye. By an impact, the dye released from the dye capsule layer is absorbed into a dye absorbing layer of the tank. The dye exudes on the surface of the dye absorbing layer and spreads. The degree of impact given to the tank is estimated from the degree of spread of the dye or the degree of density of the dye.

### TECHNICAL FIELD

The present invention relates to a tank, and relates particularly to a tank that is capable of reacting to external impact on the tank.

### BACKGROUND ART

Examples of tanks that are used to hold gases or high-pressure gases include metal tanks and FRP (Fiber Reinforced Plastic) tanks. FRP tanks are lightweight and exhibit excellent heat resistance and strength, and are therefore used as the high-pressure gas tanks installed in moving bodies such as automobiles, including the natural gas tanks mounted in natural gas vehicles, and the hydrogen high-pressure gas tanks for fuel cells that are mounted in fuel cell vehicles.

Furthermore, the metal tanks and FRP tanks mentioned above are reusable tanks which, when the gas contained therein is consumed, are refilled with additional gas. However, the metal tanks and FRP tanks described above generally tend to deteriorate in strength when exposed to external impact.

Accordingly, prior to refilling a tank with gas, the tank must be externally assessed to determine whether it has been exposed to a large impact that is sufficiently severe to prevent refilling of the tank with gas.

Methods that have been proposed for detecting such impacts include those described below. For example, JP 02-80467 A proposes a method in which paint-filled capsules are attached to a moving vehicle such as an automobile, a motorbike or a bicycle in locations that are prone to contact, or in shallow grooves close thereto, so that an object that contacts or collides with the vehicle is coated with the paint. Further, JP 05-116592 A proposes a vehicle collision detection device in which an optical fiber is wrapped around the vehicle, and a collision is detected on the basis of variations in the light transmission properties of the optical fiber. Furthermore, JP 04-251784 A proposes a wrapping sheet having cushioning and protective functions that is used to cover the periphery of a drum used for packaging an electrical cable, wherein a pressure-sensitive coloring sheet is provided on the outer surface of the wrapping sheet, so that if the drum is exposed to localized pressure or impact during packaging of the electrical cable within the drum, the pressure-sensitive coloring sheet develops a color, enabling localized pressure or impacts on the electrical cable to be detected even if the electrical cable packaged inside the drum exhibits no deformation.

Moreover, JP 2007-16988 A discloses a high-pressure tank provided with a heat storage material. Furthermore, JP 08-35598 A discloses a vessel in which a damage mitigating material that is able to undergo physical deformation upon external impact is disposed within the thickest portion of an outer shell formed from a wound filament material.

In the method described above in which a paint is adhered to the colliding object, it is difficult to leave an indication of the strength of the impact on the tank surface, making it impossible to estimate the level of damage to the tank on the basis of the strength of the tank impact. Further, if the above method of using variations in the light transmission properties of an optical fiber to detect collisions is used for detecting tank impacts, then the size of tank itself increases relative to the tank contents, making installation of such a tank in a vehicle or the like problematic. Furthermore, in the case of a wrapping sheet having a pressure-sensitive coloring sheet provided on the outermost surface, even a small impact tends to result in coloration spreading across the sheet, meaning it is difficult to ascertain whether or not the tank has been exposed to a large impact that is sufficiently severe to prevent refilling of the tank with gas, thus increasing the possibility of a reduction in the number of times the tank can be reused.

### DISCLOSURE OF INVENTION

The present invention has been developed in light of the above circumstances, and provides a tank for which assessment of whether the tank has been exposed to a large impact that is sufficiently severe to prevent refilling of the tank can be performed simply.

In order to achieve such a tank, the tank according to the present invention has the features described below.

(1) A tank for storing gas, wherein the tank is provided with a dye capsule layer comprising capsules containing a dye.

The capsules containing the dye within the dye capsule layer are ruptured during an impact on the tank, and the degree of spread of the resulting coloration across the tank surface varies depending on the size of the impact. This means the size of the impact can be estimated.

(2) The tank described in (1) above, wherein a dye absorbing layer capable of absorbing the dye is provided on the outermost layer of the tank.

The dye released from the dye capsule layer upon impact is absorbed by the dye absorbing layer on the outermost layer of the tank, and this dye then exudes out and spreads across the surface of the dye absorbing layer, meaning the size of the impact on the tank can be estimated from the degree of spread of the dye, or the degree of density of the dye.

(3) A tank for storing gas, wherein an impact recording layer that is capable of recording deformation caused by impact is provided on the outermost layer of the tank, and the impact recording layer comprises a heat insulating material layer that has a heat insulating function and is capable of retaining deformation, a dye capsule layer that is provided on the outer surface of the heat insulating material layer and comprises capsules containing a dye, and a dye absorbing layer that is provided on the outer surface of the dye capsule layer and is capable of absorbing the dye.

The impact recording layer has a heat insulating function provided by the heat insulating material layer, and because the heat insulating material layer deforms upon impact, causing the dye to be released from the dye capsule layer and absorbed by the dye absorbing layer, and to then exude out and spread across the surface of the dye absorbing layer, the size of the impact on the tank can be estimated from the degree of spread of the dye, the degree of density of the dye, or the degree of deformation of the heat insulating material layer.

(4) A tank for storing gas, wherein an impact recording layer that is capable of recording deformation caused by impact is provided on the outermost layer of the tank, and the impact recording layer comprises a dye capsule layer comprising capsules containing a dye, a heat insulating material layer that is provided on the outer surface of the dye capsule layer, has a heat insulating function and is capable of retaining deformation, and a dye absorbing layer that is provided on the outer surface of the heat insulating material layer and is capable of absorbing the dye.

The impact recording layer has a heat insulating function provided by the heat insulating material layer, and the heat insulating material layer deforms upon impact, causing the dye to be released from the dye capsule layer. The dye then passes through the heat insulating material layer, is absorbed by the dye absorbing layer, and then exudes out and spreads across the surface of the dye absorbing layer. Accordingly, in those cases where the dye has spread across the dye absorbing layer, it is immediately apparent that the impact was sufficiently large to cause the dye to pass through the heat insulating material layer and exude out of the dye absorbing layer, and the size of the impact on the tank can be estimated from the degree of spread of the dye, the degree of density of the dye, or the degree of deformation of the heat insulating material layer.

(5) A tank for storing gas, wherein an impact recording layer that is capable of recording deformation caused by impact is provided on the outermost layer of the tank, and the impact recording layer comprises a dye-containing capsule-containing heat insulating material layer that comprises capsules containing a dye, has a heat insulating function and is capable of retaining deformation, and a dye absorbing layer that is provided on the outer surface of the dye-containing capsule-containing heat insulating material layer and is capable of absorbing the dye.

The impact recording layer has a heat insulating function, and upon impact, the dye-containing capsule-containing heat insulating material layer undergoes deformation, and the dye that is released from the dye-containing capsules of the dye-containing capsule-containing heat insulating material layer is absorbed by the dye absorbing layer and then exudes out and spreads across the surface of the dye absorbing layer. Accordingly, the size of the impact on the tank can be estimated from the degree of spread of the dye, the degree of density of the dye, or the degree of deformation of the dye-containing capsule-containing heat insulating material layer.

(6) The tank described in any one of (1) to (5) above, wherein the dye is a fluorescent substance.

By using a fluorescent substance as the dye, the size of an impact on the tank and the direction in which the impact occurred can be detected with good accuracy based on the amount of fluorescence and the concentration of the fluorescence emanating from the fluorescent substance exposed on the surface of the tank.

(7) The tank described in any one of (1) to (6) above, wherein a layer of a heat storage material is provided between the outer surface of the tank body and the impact recording layer, between the outer surface of the tank body and the heat insulating material layer, between the tank body and the dye capsule layer, or between the tank body and the dye-containing capsule-containing heat insulating material layer.

By providing a layer of a heat storage material, the heat generated by the thermal energy that is released when the gas stored in the tank undergoes a phase change can be stored by the heat storage material, whereas the supercooling arising as a result of the thermal energy absorption that accompanies the reverse phase change to that mentioned above can be suppressed by the heat stored during the release of thermal energy described above. On the other hand, cold energy arising as a result of the thermal energy absorption that accompanies phase change can be stored, whereas the heating that is generated by the release of thermal energy that accompanies the reverse phase change to that mentioned above can be suppressed by the cold energy stored during the thermal energy absorption described above.

(8) The tank described in (7) above, wherein the tank is a high-pressure tank that is filled with a high-pressure gas.

In a high-pressure tank, because the tank is filled with a high-pressure gas, it is particularly important that an assessment can be made as to whether or not the tank has been exposed to a large impact that is sufficiently severe to prevent refilling of the tank with high-pressure gas.

(9) A tank for storing gas, wherein an impact recording layer that is capable of recording deformation caused by impact is provided on the outermost layer of the tank, and the impact recording layer comprises a heat insulating material layer that has a heat insulating function and is capable of retaining deformation, and a colored layer that is provided immediately beneath the heat insulating material layer and is colored a different color from the color of the heat insulating material layer.

Because the colored layer provided directly beneath the heat insulating material layer is exposed in any locations damaged by an impact on the heat insulating material layer, the severity of the impact can be estimated from the change in color at the tank surface and the surface area of the exposed color portions.

### BRIEF DESCRIPTION OF THE DRAWINGS

FIG. 1 is a cross-sectional view of one example of a tank according to a first embodiment of the present invention.

FIG. 2 is a cross-sectional view of one example of a tank according to a second embodiment of the present invention.

FIG. 3 is a cross-sectional view of one example of a tank according to a third embodiment of the present invention.

FIG. 4 is a cross-sectional view of one example of a tank according to a fourth embodiment of the present invention.

FIG. 5 is a cross-sectional view of one example of a tank according to a fifth embodiment of the present invention.

### BEST MODE FOR CARRYING OUT THE INVENTION

A description of embodiments of the present invention, based on the drawings, is presented below.

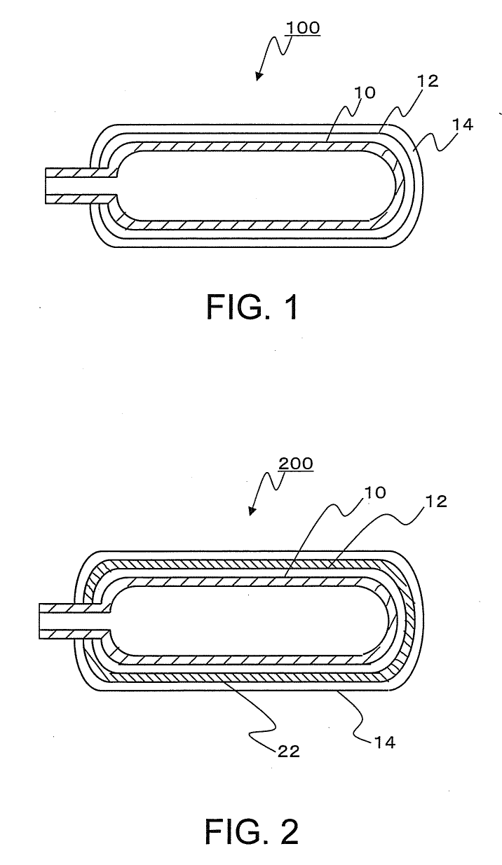

An example of a tank according to a first embodiment of the present invention is illustrated in FIG. 1. As illustrated in FIG. 1, a tank 100 according to this embodiment is a tank for storing gas, wherein an impact recording layer that is capable of recording deformation caused by impact is provided on the outermost layer of the tank, and the impact recording layer comprises a heat insulating material layer 14 having a heat insulating function. Moreover, as illustrated in FIG. 1, the tank 100 according to this embodiment has a heat storage material layer 12 provided on the outer surface of a tank body 10, and the heat insulating material layer 14 is provided on the outer surface of the heat storage material layer 12.

Examples of materials that may be used for the tank body include metals such as steel in the case of typical vertically positioned tanks, and lightweight and strong FRP (Fiber Reinforced Plastics) and the like in the case of tanks mounted in moving bodies such as vehicles.

Furthermore, the heat storage material layer 12 is preferably composed of a latent heat storage material that stores the heat generated by the thermal energy that is released when the gas stored in the tank 100 undergoes a phase change, and suppresses the supercooling arising as a result of the thermal energy absorption that accompanies the reverse phase change to that mentioned above by employing the heat stored during the release of thermal energy described above, and moreover, is preferably composed of a latent heat storage material that stores the cold energy arising as a result of the thermal energy absorption that accompanies phase change, and suppresses the heating that is generated by the release of thermal energy that accompanies the reverse phase change to that mentioned above by employing the cold energy stored during the thermal energy absorption described above.

When the heat storage material layer 12 functions as a cold storage layer, the heat storage material layer 12 can employ a material prepared by gelling or thickening an aqueous solution containing a refrigerant and then encapsulating the gelled or thickened aqueous solution within a synthetic resin pouch, impregnating a porous material with an aqueous solution containing a refrigerant and then encapsulating the impregnated porous material within a synthetic resin pouch, and impregnating a porous material with a typical gel-like substance that functions as a refrigerant. Examples of materials that may be used as the refrigerant include mixtures containing predetermined proportions of a para-benzoate ester, calcium hydroxide and carboxymethylcellulose (CMC), ethylene glycol, and ammonia and the like. Further, examples of materials that may be used as the above porous materials include elastomeric foams such as urethane foams.

The heat insulating material of the heat insulating material layer 14 may be composed of gypsum, lime plaster, paper, fiber, or combinations thereof, and is a material that exhibits a heat insulating function, has similar or inferior strength to that of the tank body, and is capable of retaining an irreversible deformation upon deformation caused by an external impact. Furthermore, in those cases where, for example, the tank body has a diameter of 300 mm and a tank body length of 800 mm, the thickness of the heat insulating material layer 14 is preferably not less than 20 mm. If the thickness of the heat insulating material layer 14 is less than 20 mm, then all impacts above a certain severity only leave evidence of a similar size, meaning it is impossible to ensure that the size of the evidence left on the tank corresponds with the size of the impact, and as a result, it can be difficult to estimate the size of the impact.

An example of a tank according to a second embodiment of the present invention is illustrated in FIG. 2. Those structural elements that are the same as structural elements described above for the first embodiment are labeled using the same symbols, and description of these elements is omitted.

As illustrated in FIG. 2, a tank 200 according to this embodiment is a tank for storing gas, wherein the impact recording layer comprises a heat insulating material layer 14 that has a heat insulating function and is capable of retaining deformation, and a colored layer 22 that is provided immediately beneath the heat insulating material layer 14 and is colored a different color from the color of the heat insulating material layer 14. Moreover, as illustrated in FIG. 2, the tank 200 according to this embodiment has a heat storage material layer 12 provided on the outer surface of the tank body 10, the colored layer 22 is provided on the outer surface of the heat storage material layer 12, and the heat insulating material layer 14 is provided on the outer surface of the colored layer 22.

The colored layer 22 may be any color, provided the color is different from that of the heat insulating material layer 14. Examples of the material for the colored layer 22 include colored films, colored papers or fibers, and colored gypsum or lime plaster. Because the colored layer 22 is provided immediately beneath the heat insulating material layer 14, the colored layer 22 beneath the heat insulating material layer 14 is exposed in any locations damaged by an impact on the heat insulating material layer 14, meaning the severity of the impact can be estimated from the change in color at the tank surface and the surface area of the exposed color portions.

Furthermore, tanks according to other embodiments of the present invention are tanks for storing gas that are provided with a dye capsule layer comprising capsules containing a dye. In this type of configuration, the capsules containing the dye within the dye capsule layer rupture when the tank is exposed to impact, and because the degree of spread of the coloration caused by the dye on the tank surface varies in accordance with the size of the impact, the size of the impact can be estimated from the degree of spread of the coloration.

Moreover, in the embodiments described above, a dye absorbing layer capable of absorbing the dye is provided on the outermost layer of the tank. As a result, the dye released from the dye capsule layer upon impact is absorbed by the dye absorbing layer that represents the outermost layer of the tank, and the dye then exudes out from the surface of the dye absorbing layer and spreads across the layer surface, meaning the size of the impact can be estimated from the degree of spread of the dye or the degree of density of the dye.

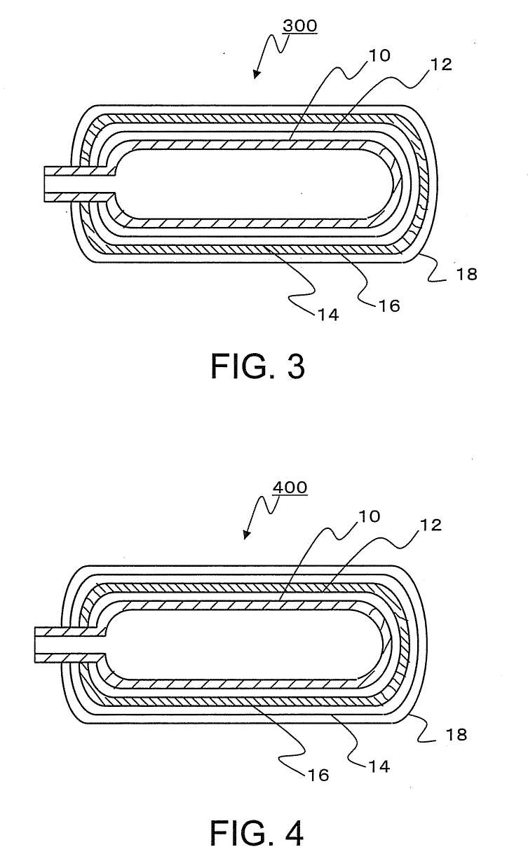

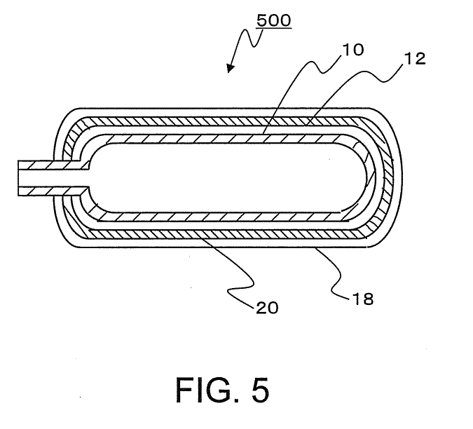

The structures of tanks according to these other embodiments of the present invention are described below as the third, fourth and fifth embodiments, using FIG. 3, FIG. 4 and FIG. 5 respectively. In the third, fourth and fifth embodiments, those structural elements that are the same as structural elements described above for the first and second embodiments are labeled using the same symbols, and description of these elements is omitted.

FIG. 3 illustrates a tank 300 according to the third embodiment. The tank 300 is a tank for storing gas, wherein a heat storage material layer 12 is provided on the outer surface of the tank body 10, and an impact recording layer is provided on the outer surface of the heat storage material layer 12. The impact recording layer comprises a heat insulating material layer 14 that is provided on the outer surface of the heat storage material layer 12, has a heat insulating function and is capable of retaining deformation, a dye capsule layer 16 that is provided on the outer surface of the heat insulating material layer 14 and comprises capsules containing a dye, and a dye absorbing layer 18 that is provided on the outer surface of the dye capsule layer 16 and is capable of absorbing the dye.

In the impact recording layer of this embodiment, the heat insulating material layer 14 provides a heat insulating function, and the heat insulating material layer 14 also deforms upon impact, causing the dye to be released from the dye capsule layer 16 and absorbed by the dye absorbing layer 18, and to then exude out and spread across the surface of the dye absorbing layer 18. Accordingly, the spread of the dye is sensitive to impacts, meaning not only can the fact that an impact has occurred be ascertained rapidly from the degree of spread of the dye, but the size of the impact on the tank can be estimated from the degree of density of the dye, and from the degree of deformation of the heat insulating material layer.

The dye in the dye capsule layer 16 may be any type of dye, although a fluorescent substance is preferred. By using a fluorescent substance, the size of an impact, the direction in which the impact occurred and the depth direction of the impact can be detected with good accuracy based on the amount of fluorescence and the concentration of the fluorescence emanating from the fluorescent substance exposed on the surface of the tank. For the fluorescent substance, the use of the types of substances typically used in fluorescent dyes and fluorescent coating materials is ideal. Furthermore, the encapsulation process for incorporating the dye within the capsules may be conducted using normal methods, and examples of materials that can be used as the capsule film include gelatin, CMC, and ethylene-maleic anhydride copolymers. The strength of the capsule film has a rupture strength that corresponds with the size of impact, so that detection can be made as to whether or not the tank has been exposed to a large impact that is sufficiently severe to prevent refilling of the tank with gas.

Furthermore, the dye absorbing layer 18 may be composed of any material that is capable of absorbing the dye, although paper materials, fibers, gypsum, lime plaster, or combinations thereof are preferred.

For example, in the case of a tank body having a diameter of 300 mm and a tank body length of 800 mm, the thickness of the impact recording layer comprising the heat insulating material layer 14, the dye capsule layer 16 and the dye absorbing layer 18 is preferably not less than 20 mm. If the thickness of the impact recording layer is less than 20 mm, then all impacts above a certain severity only leave evidence and/or dye coloration of a similar size, meaning it is impossible to ensure that the size of the evidence or dye coloration left on the tank corresponds with the size of the impact, and as a result, it can be difficult to estimate the size of the impact.

FIG. 4 illustrates a tank 400 according to the fourth embodiment. The tank 400 is a tank for storing gas, wherein a heat storage material layer 12 is provided on the outer surface of the tank body 10, and an impact recording layer is provided on the outer surface of the heat storage material layer 12. The impact recording layer comprises a dye capsule layer 16 comprising capsules containing a dye, a heat insulating material layer 14 that is provided on the outer surface of the dye capsule layer 16, has a heat insulating function and is capable of retaining deformation, and a dye absorbing layer 18 that is provided on the outer surface of the heat insulating material layer 14 and is capable of absorbing the dye.

In the impact recording layer of this embodiment, the heat insulating material layer 14, which is permeable to the dye, provides a heat insulating function, and the heat insulating material layer 14 also deforms upon impact, causing the dye to be released from the dye capsule layer 16, pass through the heat insulating material layer 14, be absorbed by the dye absorbing layer 18, and then exude out and spread across the surface of the dye absorbing layer 18. Accordingly, in those cases where the dye has spread across the dye absorbing layer 18, it is immediately apparent that the impact was sufficiently large to cause the dye to pass through the heat insulating material layer 14 and exude out of the dye absorbing layer 18, and the size of the impact on the tank can be estimated from the degree of spread of the dye, the degree of density of the dye, and the degree of deformation of the heat insulating material layer. In other words, unlike the tank 300 according to the third embodiment, only large impacts can be recorded. Further, the heat insulating material layer 14 in this embodiment must comprise a material through which the dye is able to penetrate, and examples of this material include gypsum, lime plaster, paper materials, fibers, and combinations thereof.

FIG. 5 illustrates a tank 500 according to the fifth embodiment. The tank 500 is a tank for storing gas, wherein a heat storage material layer 12 is provided on the outer surface of the tank body 10, and an impact recording layer is provided on the outer surface of the heat storage material layer 12. The impact recording layer comprises a dye-containing capsule-containing heat insulating material layer 20 that comprises capsules containing a dye, has a heat insulating function and is capable of retaining deformation, and a dye absorbing layer 18 that is provided on the outer surface of the dye-containing capsule-containing heat insulating material layer 20 and is capable of absorbing the dye.

The dye-containing capsule-containing heat insulating material layer 20 is a layer that is formed by dispersing dye-containing capsules, which are formed from the capsule film and dye described above in the third embodiment, within an aforementioned heat insulating material composed of gypsum, lime plaster, paper, fiber, or a combination thereof.

Accordingly, the impact recording layer of this embodiment provides a heat insulating function, and upon impact, the dye-containing capsule-containing heat insulating material layer 20 undergoes deformation, and the dye that is released from the dye-containing capsules of the dye-containing capsule-containing heat insulating material layer 20 is absorbed by the dye absorbing layer 18 and then exudes out and spreads across the surface of the dye absorbing layer 18. Accordingly, the size of the impact on the tank can be estimated from the degree of spread of the dye, the degree of density of the dye, and the degree of deformation of the dye-containing capsule-containing heat insulating material layer 20.

In the tank 100 to tank 500 of the first to fifth embodiments described above, because factors such as the strength of the heat insulating material layer 14, the strength of the capsule film containing the dye, and the dye absorption rate of the dye absorbing layer 18 are all known, the size of an impact can be measured with good accuracy based on the degree of deformation (for example, the size of the deformation, the depth of the deformation, and the shape of the deformation) of the heat insulating material layer 14 formed on the tank that has been exposed to the impact, and the degree of dye coloration (for example, the surface area colored by the dye, the density of the coloration, and the shape of the colored area).

The tank 100 to tank 500 of the first to fifth embodiments described above can be used as high-pressure tanks for storing high-pressure gas. In a high-pressure tank, because the tank is filled with a high-pressure gas, it is particularly important that an assessment can be made as to whether or not the tank has been exposed to a large impact that is sufficiently severe to make refilling of the tank with high-pressure gas impossible.

For example, a high-pressure hydrogen gas tank mounted in a vehicle is typically filled with hydrogen gas at 700 atmospheres. Further, the high-pressure hydrogen gas tank is frequently housed beneath the vehicle floor, and considering the environment in which the tank is housed, enabling the degree of any impacts to be recorded on the tank should enable safer refilling of the tank with high-pressure hydrogen gas.

According to the present invention, the size of any impact on the tank can be estimated, and an assessment can be made as to whether or not gas filling is possible.

Although the present invention has been described in detail above, the scope of the present invention is not limited to the specific configurations described above.

Furthermore, the detailed description, claims, drawings and abstract of the inventions disclosed in Japanese Patent Application No. 2007-137418, filed on May 24, 2007, are deemed to be incorporated in their entirety within the present application.

### INDUSTRIAL APPLICABILITY

A tank according to the present invention may be used in any application that requires a tank, but is particularly suited to tanks used for storing a high-pressure gas, and is ideal for the high-pressure gas tanks mounted in moving bodies such as automobiles.

1. (canceled)

2. A tank for storing gas, wherein
the tank is provided with a dye capsule layer comprising capsules containing a dye, and
a dye absorbing layer capable of absorbing dye is provided on an outermost layer of the tank.

3. A tank for storing gas, wherein
an impact recording layer that is capable of recording deformation caused by impact is provided on an outermost layer of the tank, and
the impact recording layer comprises a heat insulating material layer that has a heat insulating function and is capable of retaining deformation,
a dye capsule layer that is provided on an outer surface of the heat insulating material layer and comprises capsules containing a dye, and
a dye absorbing layer that is provided on an outer surface of the dye capsule layer and is capable of absorbing dye.

4. A tank for storing gas, wherein
an impact recording layer that is capable of recording deformation caused by impact is provided on an outermost layer of the tank, and
the impact recording layer comprises a dye capsule layer comprising capsules containing a dye,
a heat insulating material layer that is provided on an outer surface of the dye capsule layer, has a heat insulating function, and is capable of retaining deformation, and
a dye absorbing layer that is provided on an outer surface of the heat insulating material layer and is capable of absorbing dye.

5. A tank for storing gas, wherein
an impact recording layer that is capable of recording deformation caused by impact is provided on an outermost layer of the tank, and
the impact recording layer comprises a dye-containing capsule-containing heat insulating material layer that comprises capsules containing a dye, has a heat insulating function, and is capable of retaining deformation, and
a dye absorbing layer that is provided on an outer surface of the dye-containing capsule-containing heat insulating material layer and is capable of absorbing dye.

6. (canceled)

7. The tank according to claim 2, wherein
the dye is a fluorescent substance.

8. The tank according to claim 3, wherein
the dye is a fluorescent substance.

9. The tank according to claim 4, wherein
the dye is a fluorescent substance.

10. The tank according to claim 5, wherein
the dye is a fluorescent substance.

11. The tank according to claim 3, wherein
a layer of a heat storage material is provided between an outer surface of a body of the tank and the impact recording layer, between an outer surface of a body of the tank and the heat insulating material layer, between a body of the tank and the dye capsule layer, or between a body of the tank and the dye-containing capsule-containing heat insulating material layer.

12. The tank according to claim 4, wherein
a layer of a heat storage material is provided between an outer surface of a body of the tank and the impact recording layer, between an outer surface of a body of the tank and the heat insulating material layer, between a body of the tank and the dye capsule layer, or between a body of the tank and the dye-containing capsule-containing heat insulating material layer.

13. The tank according to claim 5, wherein
a layer of a heat storage material is provided between an outer surface of a body of the tank and the impact recording layer, between an outer surface of a body of the tank and the heat insulating material layer, between a body of the tank and the dye capsule layer, or between a body of the tank and the dye-containing capsule-containing heat insulating material layer.

14. (canceled)

15. The tank according to claim 2, wherein
the tank is a high-pressure tank that is filled with a high-pressure gas.

16. The tank according to claim 3, wherein
the tank is a high-pressure tank that is filled with a high-pressure gas.

17. The tank according to claim 4, wherein
the tank is a high-pressure tank that is filled with a high-pressure gas.

18. The tank according to claim 5, wherein
the tank is a high-pressure tank that is filled with a high-pressure gas.

19. The tank according to claim 7, wherein
the tank is a high-pressure tank that is filled with a high-pressure gas.

20. (canceled)
